(19) United States
(12) Patent Application Publication
(10) Pub. No.: US 2007/0261720 A1
(43) Pub. Date: Nov. 15, 2007

(54) Voc Free Coatings Strippers

(75) Inventors: Gerald Sugerman, Allendale, NJ (US); James V. Cosby, Groton, CT (US)

Correspondence Address: EDWARDS ANGELL PALMER & DODGE LLP, P.O. BOX 55874, BOSTON, MA, 02205, US

(73) Assignee: VOCFREE, Inc.

(21) Appl. No.: 10/551,616

(22) PCT Filed: Apr. 5, 2004
(86) PCT No.: PCT/US04/10666

§ 371 Date: Oct. 17, 2006

Related U.S. Application Data
(60) Provisional application No. 60/460,060, filed on Apr. 3, 2003.

(51) Int. Cl. C11D 1/72; B08B 3/04; C11D 3/30

(52) U.S. Cl. 134/38; 510/475

(57) ABSTRACT

Utilization of certain essentially nonvolatile oligo alkylene glycols and or their mono alkyl ethers, and/or hydroxy esters thereof, in combination with selected, optionally (partially) neutralized, nonvolatile hydroxyl group bearing di/oligoamines, optionally in conjunction with defoamers, water, and/or wetting agents, have been found to produce VOC free, minimally corrosive, highly efficient strippers for coatings, such as paints, printing inks, and floor waxes.

### CROSS-REFERENCE TO RELATED APPLICATIONS

This application claims benefit of U.S. Application Ser. No. 60/460,060, filed Apr. 3, 2003, which is incorporated by reference in its entirety.

### BACKGROUND

Conventional strippers employed to assist in the removal of polymeric organic coatings from solid substrates (strippers) generally contain substantial proportions of volatile organic solvents (typically glycol ethers, ketones and/or esters), often in combination with corrosives such as ammonia, volatile amines, and/or caustic soda. These strippers expose applicators, and bystanders, to the flammability, and toxicity hazards associated with inhalation of said volatiles, especially during prolonged periods of use, under poorly ventilated conditions. In addition to degrading the health and safety of persons in the immediate vicinity of usage, application of these hazardous materials in facilities employing air recirculation for heating and/or air conditioning purposes results in excessive- and unintended exposure, at lower concentrations, to a much larger group of individuals.

### SUMMARY

It has now been surprisingly found that the replacement of the aforementioned volatile organic solvents, volatile amines, and caustics, by a combination of essentially nonvolatile oligomeric alkylene glycol(s) and/or certain of their mono ethers, and/or ether hydroxy esters, (cf. Formula A), and (optionally partially acid neutralized) di/oligo amines (cf. Formula B), optionally, but preferably in combination with defoamers, wetting agents and/or water, provides the user with a combination of both enhanced performance, and substantially reduced odor, and handling hazards.

One embodiment relates to a composition of matter including (e.g., comprising, essentially consisting of) one or more oligo alkylene glycols and/or their mono alkyl ethers, and hydroxy esters derived from said oligoglycols and or related mono ethers. in combination with one or more, (partially) neutralized, nonvolatile di/oligoamines, corresponding to formulas A and B, respectively. A limited selection of preferred embodiments of materials corresponding to Formulas A and B are exemplified in Tables A and B respectively
R(OR′)ₓOA Formula A
wherein each R is independently hydrogen, or a monovalent, saturated one to six carbon hydrocarbyl ligand (e.g., methyl, ethyl, isopropyl, butyl, 2-butyl, tertiary butyl, neo-pentyl, cyclohexyl) or a phenyl group, each R′ is independently chosen from among divalent saturated two to six carbon hydrocarbyl ligands (e.g., 1,2-ethyl, 1,2-propyl,1,3-propyl, 1,2-butyl, 1,4-butyl, 1,3-(2-methyl)propyl, 1,3-neo-pentyl, 1,4-cyclohexyl), each A is a mono valent ligand chosen from among hydrogen or a 2 to four carbon hydroxy acyl group, and x is an integer from 3 to 20, inclusive:
R1R2NR3[(R4)NR5]_{y}H Formula B
wherein R1, R2, R4 are each independently chosen from among hydrogen, methyl, ethyl isopropyl and propyl ligands, and/or from 2-hydroxy ethyl or 2, or 3, hydroxy propyl ligands, and each R3, and each R5 is independently chosen from among two to 12 carbon divalent saturated hydrocarbyl, or ether ligands. (e.g., 1,2-ethenylene, 1,2-propylene, 1,4-butyene, 1,3-cyclopentenyl, 4,4′-bis cyclohexyl ether, 2-cyclopentyl, methyleneoxy 1,5-hexylene), and y is an integer from 0 to 5, inclusive.

In another aspect, the composition includes (or is made using) a compound of Formula B, wherein the compound of Formula B has only one amine hydrogen atom, that is, only one of R1, R2, R3, R4 and R5 is independently and simultaneously H. In such instances, all nitrogen atoms in the compound of Formula B (with the exception of one, that being the nitrogen with the one hydrogen substituent) are tertiary-substituted nitrogen atoms.

Another embodiment relates to a composition of matter according to any of those delineated herein, wherein the pH of the composition has been adjusted (preferably via carbon dioxide addition) such that the mixture has a pH in the range of 6 to 8, alternatively 6 to 7, or alternatively 7 to 8, or alternatively any acceptable pH physiologically suitable for contact to skin and/or mucus membranes with acceptable or no irritation.

Another embodiment relates to a composition of matter (or method of making such) according to any of those delineated herein, wherein the degree of neutralization has been adjusted such that dilution with from one to 10 volumes, alternatively one to 5 volumes of water per volume of instant invention composition produces a mixture having a pH in the range of 6 to 8, or alternatively any acceptable pH physiologically suitable for contact to skin and/or mucus membranes with acceptable or no irritation.

Another embodiment relates to a composition of matter according to any of those delineated herein wherein the neutralizing agent is a di or polybasic acid (see, e.g., Table C).

Another embodiment relates to a composition of matter according to any of those delineated herein used for the purpose of removing polymeric organic coatings such as waxes, printing inks, and/or paints from solid substrates.

Another embodiment relates to a composition of matter according to any of those delineated herein used for the purpose of removing latex and/or oil based alkyd, epoxy, vinyl, acrylic, polyamide, and polyurethane derived waxes, printing inks, and/or paints i.e., polymeric oxygenated resins from solid substrates (e.g., tile, floor, wall, and the like; wood, ceramic, fiberglass, concrete, laminate, vinyl, polymer, metal, and the like).

Another embodiment relates to a composition of matter according to any of those delineated herein, further including defoamers, water, and/or wetting agents, inclusive of detergents, anti-redeposition agents, anti static agents etc. Another embodiment relates to a composition of matter according to any of those delineated herein, wherein the oligo alkylene glycols and/or their mono alkyl ethers are essentially nonvolatile.

Another embodiment relates to a method for removing a coating from a solid substrate including applying the composition according to any of those delineated herein, to the solid substrate. An alternate embodiment further includes removing the material resulting from the application of any of the compositions delineated herein, from the solid substrate. In alternate embodiments of the method, the coating to be removed is a wax, the coating to be removed is an ink, or the coating to be removed is a paint.

Another embodiment relates to a method for producing a composition according to any of those delineated herein, including combining one or more oligo alkylene glycols and/or their mono alkyl ethers, in combination with one or more, (optionally) neutralized, nonvolatile di/oligoamines, corresponding to formulas A and B, respectively, as defined herein. In alternate embodiments of the method, the method further includes combining one or more wax stripper additives, one or more ink stripper additives, or one or more paint stripper additives. Such additives and their use are known to those of skill in the art.

Another embodiment relates to composition of matter according to any of those delineated herein, including one or more oligo alkylene glycols and/or their mono alkyl ethers specifically delineated herein, in combination with one or more, (partially) neutralized, nonvolatile di/oligoamines, specifically delineated herein, corresponding to formulas A and B, respectively, as defined herein.

Another embodiment relates to a composition of matter according to any of those delineated herein, further including one or more di or polybasic acids specifically delineated herein.

In an alternate embodiment, the composition of matter comprises a volatile organic compound (“VOC”) free vehicle comprising any of the compositions delineated herein. The term “VOC free” refers to substances essentially not made from, or not comprising, chemical components that are considered volatile organic compounds as that term is known in the art (e.g., as defined by US EPA Method 24).

Another aspect is a composition made by the process including combining one or more oligo alkylene glycols and/or their mono alkyl ethers, in combination with one or more, optionally neutralized, nonvolatile di/oligoamines, corresponding to formulas A and B, respectively:
R(OR′)ₓOA Formula A
wherein each R is independently hydrogen, or a monovalent, saturated one to six carbon hydrocarbyl ligand or a phenyl group, each R′ is independently chosen from among divalent saturated two to six carbon hydrocarbyl ligands, each A is a mono valent ligand chosen from among hydrogen or a 2 to four carbon hydroxy acyl group. and x is an integer from 3 to 20, inclusive:
R1R2NR3 [(R4)NR5]_{y}H Formula B
wherein R1, R2, R4 are each independently hydrogen, methyl, ethyl, isopropyl, propyl, 2-hydroxyethyl or 2- or 3-hydroxypropyl ligands, and each R3, and each R5 are independently two to 12 carbon divalent saturated hydrocarbyl or ether ligands, and y is an integer from 0 to 5, inclusive. The process can further include combining one or more di or polybasic acids; combining one or more wax stripper additives, one or more ink stripper additives, or one or more paint stripper additives; or combining defoamers, water, wetting agents, or a combination thereof. The method can include that of any of the steps, processes, reagents or intermediates delineated herein.

The details of one or more embodiments of the invention are set forth in the accompanying drawings and the description below. Other features, objects, and advantages of the invention will be apparent from the description and drawings, and from the claims.

### DETAILED DESCRIPTION

As used herein the term “hydrocarbyl” refers to a radical containing hydrogen and carbon only, the term “oxa hydrocarbyl” or “ether” refers to a radical containing an ether function, that is, —O— oxygen, carbon and hydrogen only, the term “unsaturated” refers to the presence of “C═C bonding” or “carbon-carbon double bonds) in the ligand, the term “trifunctional ligand” refers to a ligand having three bonding sites [e.g., —CH(—)CH₂—, 1,3,5-C₆H₃, —OCH₂C(—)+CH(—)].

The term “multifunctional” refers to a ligand containing multiple functional groups, (e.g., an amino group and a hydroxyl group in the same ligand).

The term “neutralize” refers to the process or result of modifying the pH of a substance using an appropriate neutralization agent (i.e., acid, base, etc.).

The term “essentially nonvolatile” refers to the characteristic that the substance at issue is essentially of low volatility, or alternatively essentially meets or exceeds one or more of the following volatility criteria, and as such, is considered of a nonvolatile nature: 1) United States Environmental Protection Agency (EPA) Method 24; 2) American Society for Testing Materials (ASTM) Method D 3960; 3) has a vapor pressure ≦0.1 mm Hg at ambient temperature.

A further benefit derived from the essential non-volatility of the materials of this invention, is that unlike their volatile analogs, their persistence at the site of application, permits extremely modest proportions of stripper applications to penetrate, and loosen, relatively thick, and/or solvent resistant coating layers (upon prolonged exposure) without the necessity for repeated applications to replace volatilized components, as is required when employing conventionally formulated strippers. A wide variety of organic and/or in organic acids may be usefully employed to adjust the pH of the formulation to the range of about 6 to about 8, alternatively a pH range physiologically suitable for contact to skin and/or mucus membranes with acceptable or no irritation, in order to minimize corrosivity (cf. Table C), without materially effecting utility. Unlike conventional water reducible strippers which typically depend upon highly alkaline pHs (9+) for a significant proportion of their utility in solvating most resins, the stripping efficacy of strippers of the instant invention is virtually insensitive to pH effects within the range of ˜4 to ˜10. However the (optionally employed) neutralizing acids preferred for use in the practice of this invention are di and/or poly basic as opposed to monobasic varieties of either inorganic or organic acids. Preferred examples of neutralizing acids useful in the practice of this invention are provided in Table D.

A further characteristic of the compositions and methods relating to them, is the generation of carbon dioxide gas (including when carbon dioxide is employed as all or a portion of the neutralizing agent herein) during the use of the compositions, which makes the compositions “self-foaming” or “self-bubbling”. This quality provides enhanced efficiency in removal of the coating, ink or paint from the substrate through improved mixing, dispersion and contact of the composition with the coating, ink or paint being removed.

For certain applications low proportions of optional additives such as defoamers, (e.g., for applications involving aeration, such as rotary motion machine cleaning) and/or wetting agents, (e.g., for low surface energy substrates such as waxes) have been shown to further enhance the performance of these strippers, without materially detracting from their inherent benefits.

It should be noted that the exemplary material provide in the information provided in Tables A through D, and in conjunction with Examples 1 through 6, which follow, are intended to be illustrative, but by no means exhaustive of the scope of the compositions of matter useful in the practice of this invention, and that those skilled in the art are expected to readily appreciate from said information further analogous compositions of matter and/or applications of such materials without departing from the teachings of this invention.
R(OR′)ₓOA Formula A
Wherein each R is independently hydrogen, or a monovalent saturated one to six carbon hydrocarbyl ligand (e.g., methyl; ethyl; isopropyl; butyl; 2-butyl; tertiary butyl; neo-pentyl; cyclohexyl) or a phenyl group, each R′ is independently chosen from among divalent saturated two to six carbon hydrocarbyl ligands (e.g., 1,2-ethyl;, 1,2-propyl; 1,3-propyl; 1,2-butyl; 1,4-butyl; 1,3-(2-methyl)propyl; 1,3-neo-pentyl; 1,4-cyclohexyl), each A is a mono valent ligand chosen from among hydrogen or a 2 to four carbon hydroxy acyl group, and x is an integer from 3 to 20, inclusive.
Cf. Table A for a selection specific examples of oligo alkylene glycols and related mono ethers useful in the practice of this invention
R1R2NR3[(R4)NR5]_{y}H Formula B
Wherein R1, R2, R4 are each independently chosen from among hydrogen, methyl, ethyl, isopropyl and propyl ligands, and/or from 2-hydroxy ethyl or 2, or 3, hydroxy propyl ligands. R3, and each R5 are independently chosen from among two to 12 carbon divalent saturated hydrocarbyl, or ether ligands. (e.g., 1,2-ethenylene; 1,2-propylene; 1,4-butyene; 1,3cyclopentenyl; 4,4′-bis cyclohexyl ether; 2-cyclopentyl; methyleneoxy 1,5-hexylene), and y is an integer from 0 to 5, inclusive.

Cf. Table B for specific examples of di/oligoamines and related mono ethers useful in the practice of this invention

TABLE A

| | |
|---|---|
| A1) | Poly(1,3-)cyclopentylene glycol(400-M_{w}) |
| A2) | Penta(1,4-)butylene glycol mono 2-propyl ether |
| A3) | Polyethylene glycol(200-M_{w})mono butyl ether |
| A4) | Hexa(1,3-)propylene glycol |
| A5) | Tris(1,6-)hexylene glycol mono methyl ether |
| A6) | Polyethylene glycol(400-M_{w})mono(3-ethoxy)- |
| | 2-propyl ether |
| A7) | Octa(1,2-)propylene glycol |
| A8) | Octa(1,2-)propylene glycol mono cyclohexyl ether |
| A9) | Poly(ethylene-propylene glycol(600 M_{w}) |
| A10) | Tetrakis(bis methylol)ethane |
| A11) | Hexa(1,3-)propylene glycol mono 2-hydroxy |
| | propionate |
| A12) | Poly(1,3-)cyclopentylene glycol(400-M_{w})mono |
| | methyl ether hydroxy acetate |
| A13) | Tris(1,6-)hexylene glycol mono ethyl ether |
| | 2-hydroxy-2-methyl butyrate |
| A14) | Tris ethylene glycol mono vinyl ether 3-hydoxy |
| | propionate |
| A15) | Ethylene,1-4,butylene glycol(300 Mw0 mono propenyl |
| | ether mono 4-hydroxy butenoate |

TABLE B

| | |
|---|---|
| B1) | N¹,N²,N³,N⁴-tetra propyl ethylene diamine |
| B2) | Tetra ethylene pentamine |
| B3) | 4-(4-amino-2,butyl)morpholine |
| B4) | N,N-(bis 2-hydroxy propyl)-1,4-cyclohexane diamine |
| B5) | N²,N²-(bis butyl)-2,5-hexanediamine |
| B6) | N¹,N²,bis(2-ethoxy isopropyl)1,2,3-tris amino propane |
| B8) | Alpha, omega poly(1,2-)propylene glycol 250(M_{w}) |
| | diamine |
| B9) | 1,4,8-tris(N-methyl)cyclododecane triamine |
| B10) | Bis(6 amino)n-hexyl ether |

TABLE C

| | |
|---|---|
| C1) | Sulfuric acid |
| C2) | Phosphoric Acid |
| C3) | Citric acid |
| C4) | Methyl tetrahyhro phthalic anhydride |
| C5) | Mixed saturated C₄-C₆ dibasic acids |
| C6) | Bis(dodecyldiphenyl)oxide bis sulfonic acid |
| C7) | Fumaric acid |
| C8) | Bis n-octyl ester of bis phosphoric acid |
| C9) | Corn oil fatty acid dimer |
| C10) | Oxy bis acetic acid |
| C11) | Lauric acid |
| C12) | Lactic acid |
| C13) | Bis octyl ester of phosphoric acid |
| C14) | Toluene sulfonic acid |
| C15) | Mono octyl sulfate |
| C16) | Ricinoleic acid |
| C17) | Hydrochloric acid |
| C18) | Phenoxy acetic acid |
| C19) | Phenyl phosphonic acid |
| C20) | Glutaric acid |

TABLE D

| | |
|---|---|
| D1) | Sulfuric acid |
| D2) | Phosphoric Acid |
| D3) | Citric acid |
| D4) | Methyl tetrahyhro phthalic anhydride |
| D5) | Mixed saturated C₄-C₆ dibasic acids |
| D6) | Bis(dodecyldiphenyl)oxide bis sulfonic acid |
| D7) | Fumaric acid |
| D8) | Bis n-octyl ester of bis phosphoric acid |
| D9) | Corn oil fatty acid dimer |
| D10) | Carbon dioxide |

The invention will be further described in the following examples. Further amplification of the scope and utility of the instant invention to latex coating applications in inks, paints and stains is illustrated by the Examples. It should be understood that these examples are for illustrative purposes only and are not to be construed as limiting this invention in any manner. All references are expressly incorporated by reference in their entirety herein.

### EXAMPLES

### Example 1

This example illustrates the preparation of selected examples of the strippers of the instant invention, and their superiority as compared to conventional analogs, with respect to minimizing VOCs, flammability and corrosive pH conditions.

The indicated components were sequentially admixed, at temperatures maintained within the indicated temperature range, by employing a high sheer disperser in externally water cooled, equipment constructed of type 316 stainless steel. After dilution with 3 volumes/volume of water the resulting ready to use (RTU strippers were evaluated for pH, flash point ° C., Tag closed cup), and weight % VOC content (ASTM D3960 ) of the strippers of the instant invention and those of the indicated conventional, and their commercial analogs were evaluated and the results presented in Table 1.

TABLE 1

| Stripper | | | | |
|---|---|---|---|---|
| Designation | | | | |
| Active | | | Flash | |
| ingredients | Composition | | point | |
| (bal. Water) | weight (%) | pH | ° C. | VOC¹ |
| 1A Cutting | (Butcher Corp. | 10.5 | 29 | 9.5 |
| edge (100) | monoethanolamine | | | |
| | butoxy ethanol, | | | |
| | sodium hydroxide | | | |
| | alkyl | | | |
| | phenylsufonate | | | |
| | surfactant (APS) | | | |
| 1B Mop and | (York Supply) | 11.3 | 34 | 8.9 |
| Shine (100) | monoethanolamine | | | |
| | butoxy ethanol, | | | |
| | alkyl alcohol | | | |
| | sulfate (AAS) | | | |
| 1C | A2(10), A4(7), | 8.8 | >100 | <0.2 |
| | B1(8) | | | |
| 1D | A3(16), B6 (7) | 7.4 | >100 | <0.2 |
| | D4(2) | | | |
| 1F | A6(6), A9(5) | 7.1 | >100 | <0.2 |
| | B4(5) B7(3) | | | |
| | D2(1), AAS (0.3) | | | |
| 1G | A7(8.7), A8(1.8), | 7.6 | >100 | <0.2 |
| | B9(12), D8(5). | | | |
| 1H | A9(12), B6(5.4), | 8.3 | >100 | <0.2 |
| | B1(5.6), APS (0.4) | | | |
| 1J | A10(9), A1(6), | 8.5 | >100 | <0.2 |
| | B2(7), B5(4.5), | | | |
| | silicone² | | | |
| | (BYK 307)(0.4) | | | |
| 1K | A1(3.7), A3 (2.8), | 7.9 | >100 | <0.2 |
| | A 9(2.2), B2(4.9), | | | |
| | B9(3.8), APS(0.6) | | | |
| 1L | A1 (4.1), A3(3.7), | 6.8 | >100 | <0.2 |
| | B3(4), B5(3.5), | | | |
| | D 3 (4.5), APS (0.3), | | | |
| | Defo X123³ (0.1) | | | |

### Example 2

This example illustrates the superiority of the strippers of the instant invention as compared to the conventional materials with respect to removal of dried sheetfed ink from steel substrates.

Test panels were prepared by applying (10 micron wet thickness) coatings of magenta sheet fed process ink (VS9835, Van Saun Corp.) to clean and dry carbon steel panels (Q Panel corp.), and permitting the resulting coatings to air cure at ambient temperature for ten days. Each (undiluted) stripper was then separately evaluated by draw-down at 2 mills on each of 5 sample panels, followed sequentially by a five minute soak period, and rinsing with 20% aq. isopropanol to remove loosened and/or dissolved ink, and ambient drying overnight. The average removal from ten randomly chosen sites on each panel. Repeated applications of stripper, and soak and rinse cycles, were performed as required to effect visually complete (˜97%) ink removal. The results of these endeavors are given in Table 2.

TABLE 2

| | | | | Cycles |
|---|---|---|---|---|
| Stripper | % Removal | % Removal | % Removal | to 95% |
| designation | Cycle 1 | Cycle 2 | Cycle 3 | Removal |
| Cutting edge | 21 | 28 | 35 | >20 |
| n-pentanol | 56 | 73 | 82 | 7 |
| Kerosene | 71 | 81 | 89 | 5 |
| isoamyl ketone | 69 | 91 | 98+ | 3 |
| 1C | 70 | 89 | 98+ | 3 |
| 1F | 91 | 98+ | | 2 |
| 1H | 87 | 98+ | | 2 |
| 1J | 96 | 98+ | | 1 |

### Example 3

This example illustrates the superiority of the strippers of the instant invention as compared to the conventional materials with respect to removal of dried floor waxes from polyvinyl chloride floor tiles.

Test tiles were prepared by applying five coats (4 mil, wet thickness each) coatings of a premium grade of commercial floor wax (Signature, S.C. Johnson Corp.), with 40-45 minute drying at ambient (20-22° C.) temperature and humidity (58-62%) between coats to clean and dry, black, rigid polyvinyl chloride floor tiles (Armstrong Corp.), and permitting the resulting coatings to air-dry at ambient temperature for ten days. Each stripper was then separately evaluated @ (4:1 dilution Water:stripper), by draw-down at 5 mills on each of 5 sample tiles, followed sequentially by a 10 minute soak period, and rinsing with isopropanol to remove loosened and/or dissolved wax. Repeated applications of stripper, and soak and rinse cycles, were performed as required to effect visually complete (˜96% )wax removal. The results of these endeavors are given in Table 3.

TABLE 3

| | Cycles req. for |
|---|---|
| Stripper Designation | complete wax removal |
| Cutting Edge | 4 |
| Mop and Shine | 4 |
| 1A | 2 |
| 1B | 2 |
| 1C | 1 |
| 1D | 2 |
| 1E | 1 |
| 1F | 1 |
| 1K | 1 |
| 1J | 2 |
| 1K | 1 |
| 1L | 1 |

### Example 4

This example illustrates the superiority of the strippers of the instant invention as compared to the conventional materials with respect to removal of dried latex paint from wood flooring.

Test samples were prepared by applying (4 mil, wet thickness) coatings of a premium grade of White latex paint (Sears Best, Sears) to clean and dry, oak parquet floor panels (Boise Cascade), and permitting the resulting coatings to air-dry at ambient temperature for ten days. Each undiluted stripper was then separately evaluated by draw-down at 5 mills on each of 5 sample panels, followed sequentially by a 15 minute soak period, and rinsing with 20% aqueous isopropanol to remove loosened and/or dissolved paint. The level of paint removal from each panel was determined by the use of an laser interferometer, as the average removal from ten randomly chosen sites on each panel. Repeated applications of stripper, and soak and rinse cycles, were performed as required to effect visually complete (˜99.5%) paint removal. The results of these endeavors are given in Table 4.

TABLE 4

| | Cycles req. for complete |
|---|---|
| Stripper Designation | latex paint removal |
| Cutting Edge | 8 |
| Mop and Shine | 9 |
| Butoxy ethanol | 5 |
| 1A | 1 |
| 1B | 2 |
| 1C | 2 |
| 1D | 3 |
| 1E | 1 |
| 1F | 1 |
| 1K | 2 |
| 1J | 2 |
| 1K | 2 |
| 1L | 3 |

### Example 5

This example illustrates the superiority of the strippers of the instant invention as compared to the conventional materials with respect to removal of alkyd paint from concrete. Test panels were prepared by applying (4 mil, wet thickness) coatings of a premium grade of alkyd paint (Duron Corp. Duracote Black Gloss Enamel) to clean and dry, fully cured, smooth concrete floor panels,, and permitting the resulting coatings to air dry at ambient temperature for ten days. Each undiluted stripper was then separately evaluated by draw-down at 5 mills on each of 5 sample panels, followed sequentially by a 2 hour soak period, and rinsing with 20% isopropanol to remove loosened and/or dissolved paint, followed by ambient drying overnight, as the average removal from ten randomly chosen sites on each panel. Repeated applications of stripper, and soak and rinse cycles, were performed as required to effect visually complete paint (˜99%) removal. The results of these endeavors are given in Table 5.

TABLE 5

| | Cycles req. for |
|---|---|
| Stripper Designation | complete paint removal |
| Cutting Edge | >20 |
| Mop and Shine | >20 |
| Butoxy ethanol | 7 |
| Varnish Solvent | 7 |
| (Exxon-Varsol) | |
| Turpentine | 11 |
| 1A | 6 |
| 1B | 6 |
| 1C | 2 |
| 1D | 3 |
| 1E | 1 |
| 1F | 1 |
| 1K | 2 |
| 1J | 2 |
| 1K | 2 |

### Example 6

This example illustrates the superiority of the strippers of the instant invention as compared to the conventional materials with respect to removal of baked automotive enamel from fiberglass-polyester sheet molding compound.

Test panels were prepared by spray applying (4 mil, wet thickness) coatings of a premium grade of black acrylic-melamine automotive baking enamel (DUCO -26174) to clean and dry, sheet molding stock panels (20% E Glass SMC, Raytheon-1763), and permitting the resulting coatings to oven dry at 165-185° C. for 30 minutes. Each stripper was then separately evaluated by draw-down at 5 mills on each of 5 sample panels, followed sequentially by a 24 hour soak period, and rinsing with 50% isopropanol to remove loosened and/or dissolved paint. Repeated applications of stripper, and soak and rinse cycles, were performed as required to effect visually complete (˜99.8%) paint removal. The results of these endeavors are given in Table 6.

TABLE 6

| | Cycles req. for |
|---|---|
| Stripper Designation | complete paint removal |
| Cutting Edge | >20 |
| Mop and Shine | >20 |
| Butoxy ethanol | 17 |
| Xylene | 12 |
| Varnish Solvent | 13 |
| (Exxon-Varsol) | |
| Turpentine | >20 |
| 1B | 6 |
| 1C | 2 |
| 1D | 3 |
| 1E | 5 |
| 1F | 1 |
| 1K | 3 |
| 1J | 7 |
| 1K | 9 |

The compounds of this invention (including as used in compositions herein) may contain one or more asymmetric centers and thus occur as racemates and racemic mixtures, single enantiomers, individual diastereomers and diastereomeric mixtures. E-, Z- and cis-trans-double bond isomers are envisioned as well. All such isomeric forms of these compounds are expressly included in the present invention. The compounds of this invention may also be represented in multiple tautomeric forms, in such instances, the invention expressly includes all tautomeric forms of the compounds described herein. All such isomeric forms of such compounds are expressly included in the present invention. All crystal forms of the compounds described herein are expressly included in the present invention.

Although methods and materials similar or equivalent to those described herein can be used in the practice or testing of the present invention, suitable methods and materials are described below. In addition, the materials, methods, and examples are illustrative only and not intended to be limiting.

A number of embodiments of the invention have been described. Nevertheless, it will be understood that various modifications may be made without departing from the spirit and scope of the invention. Accordingly, other embodiments are within the scope of the following claims.

What is claimed is:

1. A composition comprising one or more oligo alkylene glycols and/or their mono alkyl ethers, in combination with one or more, optionally (partially) neutralized, nonvolatile di/oligoamines, corresponding to formulas A and B, respectively:
R(OR′)ₓOA Formula A
wherein each R is independently hydrogen, or a monovalent, saturated one to six carbon hydrocarbyl ligand or a phenyl group, each R′ is independently chosen from among divalent saturated two to six carbon hydrocarbyl ligands each A is a mono valent ligand chosen from among hydrogen or a 2 to four carbon hydroxy acyl group, and x is an integer from 3 to 20:
R1R2NR3[(R4)NR5]_{y}H Formula B
wherein R1, R2, R4 are each independently hydrogen, methyl, ethyl, isopropyl, propyl, 2-hydroxyethyl or 2- or 3-hydroxypropyl ligands, and each R3, and each R5 are independently two to 12 carbon divalent saturated hydrocarbyl or ether ligands, and y is an integer from 0 to 5, inclusive.

2. The composition according to claim 1, wherein the degree of neutralization (pH) has been adjusted such that dilution with from one to 10 volumes of water per volume of composition of claim 1 produces a mixture having a pH in the range of 6 to 8.

3. The composition according to claim 1 further comprising a neutralizing agent that is a di or polybasic acid.

4. The composition according to claim 2 further comprising a neutralizing agent that is a di or polybasic acid.

5. The composition of any of claims 1-4, further comprising defoamers, water, wetting agents, or a combination thereof.

6. The composition of any of claims 1-4, wherein the oligo alkylene glycols and their mono alkyl ethers are essentially nonvolatile.

7. A method of removing polymeric organic coatings such as waxes, printing inks, and/or paints from solid substrates, comprising application to the coating of a composition according to any of claims 1-6.

8. A method of removing waxes, printing inks, and/or paints from solid substrates, comprising application to the coating of a composition according to any of claims 1-6.

9. A method for removing a coating from a solid substance comprising applying the composition of any of claims 1-6 to the solid substance.

10. The method of claim 9, wherein the coating to be removed is a wax.

11. The method of claim 9, wherein the coating to be removed is an ink.

12. The method of claim 9, wherein the coating to be removed is a paint.

13. A method for producing a composition according to claim 1, comprising combining with one or more oligo alkylene glycols and/or their mono alkyl ethers, and or ether hydroxy esters in combination with one or more, (optionally partially) neutralized, nonvolatile di/oligoamines, corresponding to formulas A and B, respectively, as defined in claim 1.

14. A method of producing a composition according to claim 13, further comprising combining with one or more wax stripper additives, one or more ink stripper additives, or one or more paint stripper additives.

15. A composition of matter according to claim 1, comprising one or more oligo alkylene glycols and/or their mono alkyl ethers, and or ether hydroxy esters specifically delineated herein, in combination with one or more, ( optionally partially) neutralized, nonvolatile di/oligoamines, specifically delineated herein, corresponding to formulas A and B, respectively, as defined in claim 1.

16. A composition of matter as in claim 1, further comprising one or more di or polybasic acids specifically delineated herein.

17. A composition made by the process of combining with one or more oligo alkylene glycols and/or their mono alkyl ethers, and or ether esters in combination with one or more, optionally neutralized, nonvolatile di/oligoamines, corresponding to formulas A and B, respectively:
R(OR′)ₓOA Formula A
wherein each R is independently hydrogen, or a monovalent, saturated one to six carbon hydrocarbyl ligand or a phenyl group, each R′ is independently chosen from among divalent saturated two to six carbon hydrocarbyl ligands, each A is a mono valent ligand chosen from among hydrogen or a 2 to four carbon hydroxy acyl group, and x is an integer from 3 to 20:
R1R2NR3[(R4)NR5]_{y}H Formula B
wherein R1, R2, R4 are each independently hydrogen, methyl, ethyl, isopropyl, propyl, 2-hydroxyethyl or 2- or 3-hydroxypropyl ligands, and each R3, and each R5 are independently two to 12 carbon divalent saturated hydrocarbyl or ether ligands, and y is an integer from 0 to 5, inclusive.

18. The composition of claim 17, further comprising combining with one or more di or polybasic acids.

19. The composition of claim 17 or 18, further comprising combining with one or more wax stripper additives, one or more ink stripper additives, or one or more paint stripper additives.

20. The composition of any of claims 17-19, further comprising combining with defoamers, water, wetting agents, or a combination thereof.
